(19) United States
(12) Patent Application Publication
(10) Pub. No.: US 2008/0275707 A1
(43) Pub. Date: Nov. 6, 2008

(54) Voice Based Network Management Method and Agent

(76) Inventor: Muthukumar Suriyanarayanan, Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/913,313

(22) PCT Filed: May 2, 2005
(86) PCT No.: PCT/IN05/00134

§ 371 Date: Nov. 1, 2007

(51) Int. Cl. G10L 11/00; G06F 17/30

(52) U.S. Cl. 704/275; 704/270.1; 707/3; 704/E15.044; 707/E17.014

(57) ABSTRACT

A method of providing voice based device management, comprising defining a set of one or more status queries for a device, defining for each of the status queries a respective set of status responses for the device corresponding to the instantaneous status of the device, mapping the status queries to corresponding voice format status queries, and mapping the status responses to corresponding voice format status responses.

### FIELD OF THE INVENTION

The present invention relates to a voice based network management method and agent, for particular but by no means exclusive with a voice based network management information base (V-MIB), accessible by means of a voice based network management protocol.

### BACKGROUND OF THE INVENTION

Currently networked devices are typically managed by means of protocols such as the Simple Network Management Protocol (SNMP) and the like. However, such protocols—and hence the devices they manage—employ complex software tools that can discourage their use. This is particularly so with novice users seeking to manage their own networked devices, which is becoming an increasing common practice particularly as more devices—including some domestic appliances—are made networkable.

Even in the management of high-end networked devices, however, greater ease of use would be valuable for network administers.

### SUMMARY OF THE INVENTION

In one broad aspect, therefore, the present invention provides a method of providing voice based device management, comprising mapping a set of one or more status queries for a device to corresponding voice format status queries, and mapping a set of status responses for each of said status queries to corresponding voice format status responses, wherein each respective set of status responses corresponds to the instantaneous status of said device.

In one particular embodiment, the method further comprises:
defining said set status queries; and
defining said respective sets of status responses.

In another particular embodiment, the method further comprises:
defining a set of device control commands for controlling said device; and
mapping said device control commands to corresponding voice format device control commands.

The status and control commands could constitute, collectively, an interface that allows a user to perform essentially any interaction with the device. For example, a configuration interface could be constructed on this platform so that, in voice format, a user can browse and explore the various possible device configurations. In one example, the configuration interface comprises a configuration interface for a device in the form of a refrigerator, in which the configuration interface would allow a user to control a “temperature setting for chiller and freezer”. In another example, the configuration interface comprises a router configuration interface that is configured to walk the user through various configurations (such as interface speed, protocol employed and IP address).

In another aspect, the invention provides a method of managing a device, comprising:
defining a set of one or more device status queries for said device;
defining for each of said status queries a respective set of device status responses for said device corresponding to the instantaneous status of said device;
mapping said device status queries to corresponding voice format device status queries;
mapping said device status responses to corresponding voice format device status responses; and
receiving a voice format status query;
converting said voice format status query into a device status query;
checking the instantaneous status of said device and returning a corresponding device status response;
converting said device status response into a voice format status response; and
outputting said voice format status response.

In a particular embodiment, the method further comprises:
defining a set of device control commands for controlling said device;
mapping said device control commands to corresponding voice format device control commands;
receiving a voice format control command;
converting said voice format control command into a respective one of said set of device control commands; and
controlling said device according to said respective device control command.

It will be appreciated that the respective device control command may comprise a complex command that could effect or prompt a plurality of actions. Also, the method may further comprise subsequently responding to said respective device control command (such as by returning a status response such as “okay”).

Thus, the invention allows a user to interact with a (optionally networked or networkable) device by voice, so that the status of the device can be ascertained by voice alone. Also, in one embodiment, the device can also be controlled by voice. For example, the device might be a domestic appliance provided with a speaker and microphone.

In another broad aspect, the present invention provides a voice based management information base, comprising:
a set of one or more status queries for a device;
a respective set for each of said status queries of status responses for said device corresponding to the instantaneous status of said device;
a map of said status queries and respective corresponding voice format status queries; and
a map of said status responses and respective corresponding voice format status responses.

In one particular embodiment, the management information base further comprises:
a set of device control commands for controlling said device; and
a map of said device control commands and respective, corresponding voice format device control commands.

### BRIEF DESCRIPTION OF THE DRAWING

In order that the invention may be more clearly ascertained, embodiments will now be described, by way of example, with reference to the accompanying drawing, in which:

FIG. 1 is a schematic representation of the architecture of a voice based network management-system according to an embodiment of the invention, shown with a user; and

FIG. 2 is a flow chart of the steps of an example of managing the system of FIG. 1.

### DETAILED DESCRIPTION OF THE EMBODIMENTS

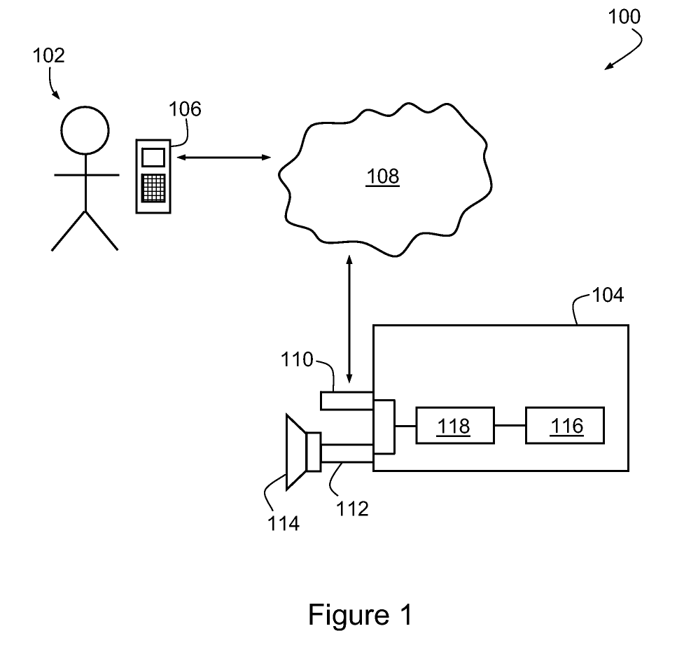

A voice based network management system according to an embodiment of the present invention is shown schematically at 100 in FIG. 1, together with a user 102. The system 100 includes an exemplary device 104 in the form of a home appliance, but it will be understood that the device could also comprise a computer (whether a personal computer, a server of a commercial enterprise, or otherwise) or any other device—networked or not—that requires management. If the device 104 is networked, the user 102 may be the operator or manager of the network.

The system 100 also includes a mobile telephone 106 that, as is described below, can be used by user 102 as a part of the system 100 for communicating with and managing device 104. The device 104 and mobile telephone 106 are in electronic communication via communications network 108. This network 108 can be in any suitable form, and in this embodiment is in the form of the Global System for Mobile Communication (GSM) network. However, as will be appreciated by those. skilled in the art, instead of mobile telephone 106, the system 100 could employ a fix line telephone, in which case the network 108 could be in the form of a copper wore or optical fiber telephone network. In still other examples, the system 100 employs a personal computer with a microphone and speaker instead of mobile telephone 106, the network 108 comprises the internet.

In other embodiments, the network 108 communicates with the other components of the system by means of a Wireless Local Loop (WLL), shortwaves or microwaves, or combinations of a number of these.

Network 108 should be distinguished from a computer or other network by means of which the device 104 is networked (if indeed it is a networked device). While network 108 could also be used to network device 104, in general network 108 provides only the communications channel by means of which the user 102 can interrogates or control the device 104, as will be described below.

The device 104 includes two interfaces: a first, telephonic interface 110 for communications via network 108 with mobile telephone 106, and a second, direct voice interface 112.

First interface 110 may alternatively comprise any form of data network port/interface (e.g. CSMA/CD based ethernet). The voice interface 112 includes a speaker/microphone 114, and is provided so that the user can communicate directly with the device 104 when in the same location as that of the device 104 (such as in the same room). It will also be appreciated, however, that these interfaces 110, 112 are described by way of example, and that the device 104 can include essentially any desired number and type of interfaces that are capable of receiving and transmitting management information in audio format.

The device 104 also includes a voice based management information base (or V-MIB) 116 and a V-MIB software agent 118. The V-MIB 116 is similar to a SNMP based management information base, and amounts to a table, tree or database of information but about the device. In addition, the V-MIB 116 is presentable in human voice based audio format with the help of V-MIB agent 118. That is, V-MIB agent 118 is adapted to facilitate interaction by the user 102 with V-MIB 116.

V-MIB 116 includes a set of predefined status queries for the device 104 and, for each of the status queries, a set of (one or more) possible status responses. Each status response reflects a possible status of the device 104 that could obtain when the relevant status query is received. It will be appreciated that here and elsewhere in this description reference to “the device” includes reference to any component of that device. Furthermore, if the device is coupled to and employed with other devices, such that collectively these devices act in concert, reference to “the device” includes reference to such other devices as required.

The V-MIB 116 also includes—or can generate when required—a number of tables or maps. A first table contains the various status queries and respective, corresponding voice format status queries; the second table contains the various status responses and respective, corresponding voice format status responses. A third table contains a list of device control commands and respective, corresponding voice format device control commands. Thus, by means of these tables, queries, responses and commands can be converted from or into voice format.

To facilitate the relating of the contents of each table to that of the others, the second table (of responses) includes a column for indicating, for each response, the identity of the query, queries, command or commands for which it may constitute a suitable response. Optionally, the first table (of queries) and third table (of commands) may each include a column for indicating, for each query or command, the identity of the response or responses that may result from issuing that respective query or command.

The status queries supported by the V-MIB 116 and V-MIB agent 118 include queries on the general status (or ‘health’) of the device and on the health of various discrete parts of the device. For example, if the device 104 is a domestic appliance (such as a refrigerator), the overall status might be that the appliance is down, whereas the status of a particular part might be that an exhaust fan is not functioning or the thermostat is malfunctioning.

Further, the status queries are of two types:

1) Static information about the device (including vendor, model number, year of manufacture, what firmware it is running, and when the device is due for servicing);

2) dynamic status information (including the ‘health’ of the device, the output of any of the device's instruments, the device's load, the instantaneous capacity of the device, and the current usage of the device).

The control commands include commands for setting the configuration of the device and of particular elements of the device, and for setting the values of both the dynamic and static status information described above.

V-MIB agent 118 includes voice recognition software for interpreting the human voice and identifying which of a series of predefined queries and commands have been received. The queries and commands are received by the V-MIB agent 118 through either the telephonic interface 110 (and hence ultimately from mobile telephone 106) or the direct voice interface 112. Once a query or command has been identified, V-MIB agent 118 uses the first and third tables described above to convert the query or command from voice format into machine format. The machine format query or command is then used to interrogate or control the device 104.

Similarly, a status response generated by the device 104 is converted by the V-MIB agent 118 (by means of the second table) into a corresponding voice format status response, and returned to the user 102 by the same interface through which was received either the status query or command that prompted the return of the status response. Thus, the user 102 can obtain status responses indicative of the status of the device 104 and—to some extent—configure and manage the device. The user 102 can, in a sense, talk to the V-MIB agent through voice interface to configure the device, and browse the MIB values or configure the device. The V-MIB agent 118 can also send voice based events or traps or alarms to a configured manager through a normal computer network interface in the form of voice format audio packets and normal data format to the V-MIB aware manager. The V-MIB agent 118 can also be configured to send traps, alarms and events directly to a network administrator as a multimedia messaging system (MMS) message, if the device is a networked device. The V-MIB agent can be configured to also send the traps, alarms and events to a voice message (or “voice mail”) system.

In some embodiments, the device 104 may be fitted with a short range microwave or radio transmitter, in which case events can be transmitted by the device over the air to a manager using radio signals or short range microwave. This is of particular value when the device 104 is a networked device, allowing one to reduce the dependency of network management on the network infrastructure that is used to manage the same network.

The V-MIB agent 118 also includes an authentication mechanism for controlling who can browse the MIB by means of the telephonic interface 110 or the direct voice interface 112. The V-MIB agent 118 may optionally include audio noise reduction algorithms for filtering noise out of voice format queries or commands.

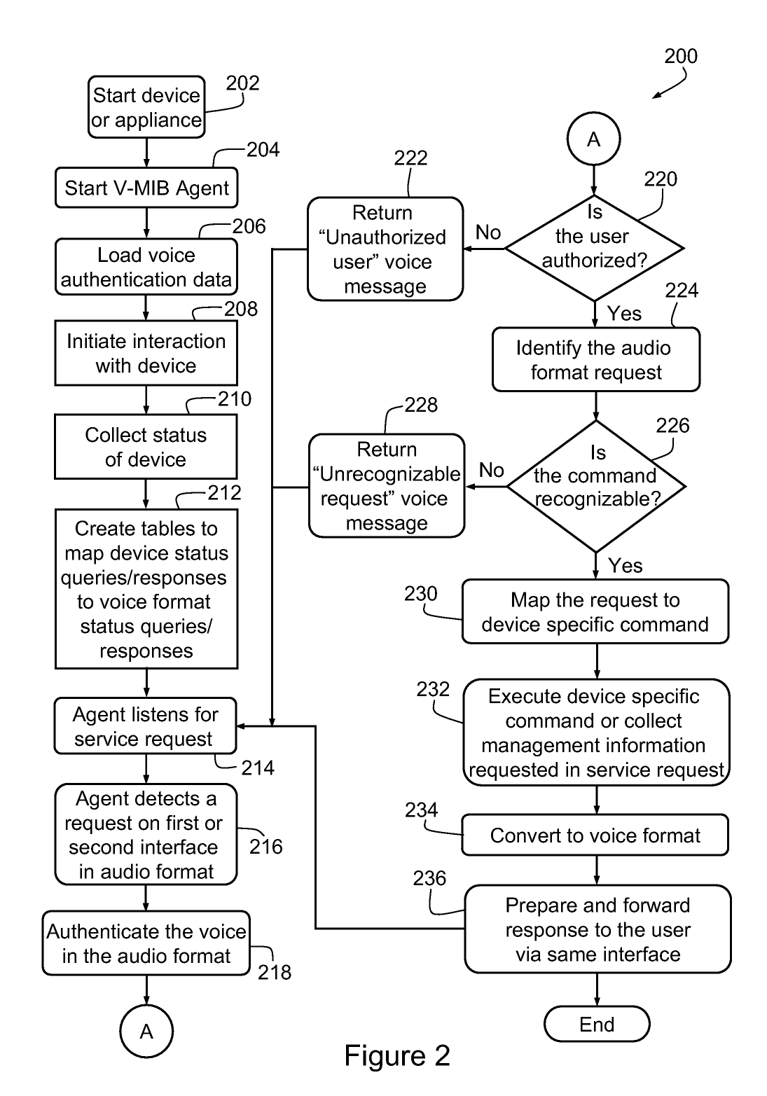

FIG. 2 is a flow chart 200 of the steps of an example of managing the system of FIG. 1. Device 104 is started (i.e. typically switched on) at step 202, which prompts the automatic execution of the V-MIB agent 118 at step 204. Next, at step 206 the V-MIB agent 118 loads voice authentication data. This data includes configurations and voice files for identifying and authorizing the voice (or equivalently the speaker) of a service request received in voice format. The authentication data constitutes, therefore, a configuration to the voice based management system; hence, when the V-MIB agent is started, it reads the configuration data so that subsequently received service requests can be authorized, as described below.

At step 208, the V-MIB agent 118 initiates interaction with the device 104, and—at step 210—the V-MIB agent 118 collects the status of device 104. At step 212, the V-MIB agent 118 creates the tables to map the device status queries, commands and responses to voice format status queries, commands and responses for populating the V-MIB 116. Then, at step 214, the V-MIB agent 118 listens for service requests, including status queries and commands.

When, at step 216, the V-MIB agent 118 detects such a request in audio format on the first or second interface 110, 112, V-MIB agent 118—at step 218—authenticates the voice in the audio format, by attempting to identify the voice and—if identifiable—determining whether that voice is authorized to issue commands. Voice identification and authorization can comprise comparing actual identification data transmitted with the voice format request with the identification data loaded at step 206, or characterizing the waveform of the voice and comparing the resulting characterization with identification data loaded at step 206 in the form of predetermined characterizations of the voices of authorized users. (Steps 206 and 218 are optional, but in this embodiment provide a useful security layer.)

At step 220, the V-MIB agent 118 checks whether the voice (and hence user) has been authorized; if not, processing passes to step 222 at which the voice message “Unauthorized user” is returned to the user through the same interface from which the request was received. Processing then returns to step 214 where the V-MIB agent 118 again listens for a service request.

If the voice (and hence user) has been authorized, the V-MIB agent 118 attempts to identify—at step 224—the audio format request. At step 226 the V-MIB agent 118 checks whether the command is recognizable; if not, processing passes to step 228 at which the voice message “Unrecognizable request” is passed to the user through the same interface from which the request was received. Processing then returns to step 214 where the V-MIB agent 118 again listens for a service request.

If the command is recognizable, processing passes to step 230, at which the V-MIB agent 118 maps the request to a device specific command. Then, at step 232, the V-MIB agent 118 executes the corresponding device specific command or collects management information according to the service request, converts (at step 234) any output (such as a status response) to voice format, and at step 236 prepares and forwards that response to the user 102 via the same interface from which the request was received. Processing then returns to step 214 where the V-MIB agent 118 again listens for a service request, unless the request was to terminate the V-MIB agent 118 in which case the process ends.

Thus, remote connectivity can be provided through telephone line or networks, and voice based management of networked and non-networked devices is made more convenient for novice users as well as for more experienced network administrators. Furthermore, a support engineer need not ask the user to collect and provide the information required for trouble-shooting faults or device configuration. Instead, the V-MIB agent 118 with a telecommunications interface allows the support engineer to dial the device 104, and to talk to the device to trouble-shoot or configure it.

In another exemplary application, in an emergency an experienced administrator could deliver control commands by means of this embodiment to manage a group of devices at a single location that are reachable by shortwave microwave or through speakers. In such a case, all the devices could receive the control commands in human voice and act (shutdown gracefully) accordingly. The control command might comprise, for example, a command to shut down all the systems in a data center; these systems would be configured to respond by shutting down gracefully.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method of providing voice based device management, comprising:
mapping a set of one or more status queries for a device to corresponding voice format status queries; and
mapping a set of status responses for each of said status queries to corresponding voice format status responses, wherein each respective set of status responses corresponds to the instantaneous status of said device.

2. A method as claimed in claim 1, further comprising:
defining said set status queries; and
defining said respective sets of status responses.

3. A method as claimed in claim 1, further comprising:
defining a set of device control commands for controlling said device; and
mapping said device control commands to corresponding voice format device control commands.

4. A method of managing a device, comprising:
defining a set of one or more device status queries for said device;
defining for each of said status queries a respective set of device status responses for said device corresponding to the instantaneous status of said device;
mapping said device status queries to corresponding voice format device status queries;
mapping said device status responses to corresponding voice format device status responses; and
receiving a voice format status query;
converting said voice format status query into a device status query;
checking the instantaneous status of said device and returning a corresponding device status response;
converting said device status response into a voice format status response; and
outputting said voice format status response.

5. A method as claimed in claim 4, further comprising:
defining a set of device control commands for controlling said device;
mapping said device control commands to corresponding voice format device control commands;
receiving a voice format control command;
converting said voice format control command into a respective one of said set of device control commands; and
controlling said device according to said respective device control command.

6. A method as claimed in claim 5, further comprising subsequently responding to said respective device control command.

7. A method of providing a voice based management information base, comprising:
providing a set of one or more status queries for a device;
providing a respective set for each of said status queries of status responses for said device corresponding to the instantaneous status of said device;
generating a map of said status queries and respective corresponding voice format status queries; and
generating a map of said status responses and respective corresponding voice format status responses.

8. A method as claimed in any one of claims 1 to 7, wherein said device is networked or networkable.

9. A device provided with program data that, when executed on the device, implements the method of any one of claims 1 to 8.

10. A computer readable medium provided with program data that, when executed on a device, implements the method of any one of claims 1 to 8.

11. A voice based management information base, comprising:
a set of one or more status queries for a networkable device;
a respective set for each of said status queries of status responses for said device corresponding to the instantaneous status of said device;
a map of said status queries and respective corresponding voice format status queries; and
a map of said status responses and respective corresponding voice format status responses.

12. A management information base as claimed in claim 11, further comprising:
a set of device control commands for controlling said device; and
a map of said device control commands and respective, corresponding voice format device control commands.
